(19) United States
(12) Patent Application Publication
(10) Pub. No.: US 2026/0213677 A1
(43) Pub. Date: Jul. 23, 2026

(54) MODULAR POWER CONVERTER with modulator connector FOR SERIES CONNECTED BATTERIES

(71) Applicant: HANWHA SOLUTIONS CORPORATION, Seoul (KR)

(72) Inventors: Ivan PETRIC, Santa Clara, CA (US); Margaret BLACKWELL, Santa Clara, CA (US); Igor LOPUSINA, Santa Clara, CA (US); Milan ILIC, Santa Clara, CA (US)

(73) Assignee: HANWHA SOLUTIONS CORPORATION, Seoul (KR)

(21) Appl. No.: 19/455,030

(22) Filed: Jan. 21, 2026

Related U.S. Application Data
(60) Provisional application No. 63/748,131, filed on Jan. 22, 2025.
(60) Provisional application No. 63/755,608, filed on Feb. 7, 2025.

(51) Int. Cl. H02M 7/797; H02J 3/32; H02J 7/00; H02J 7/02; H02J 7/50; H02M 1/00; H02M 7/00

(52) U.S. Cl. CPC H02M 7/797; H02J 3/32; H02J 7/02; H02J 7/50; H02J 7/855; H02M 1/007; H02M 7/003; H02J 2207/20

(57) ABSTRACT

A modular converter comprising a first converter switching cell configured to convert a first input into a first output; a second converter switching cell configured to convert the first input into a second output; a modular connector between the first converter switching cell and the second converter switching cell, the modular connector configured to switch between a first connection state and a second connection state, the first connection state connecting a first-port of the first converter switching cell and a first-port of the second converter switching cell in series, and the second connection state connecting the first-port of the first converter switching cell and first port of the second converter switching cell in parallel; and a transformer configured to combine the first output and the second output to form a combined output, wherein the first output, the second output, and the combined output are AC.

### CROSS-REFERENCE TO RELATED APPLICATIONS

This application claims the benefit of U.S. Provisional Application No. 63/748,131, filed on Jan. 22, 2025 and U.S. Provisional Application No. 63/755,608, filed on Feb. 7, 2025. The entire disclosures of the above applications are incorporated herein by reference.

### FIELD

Some example embodiments of the inventive concepts generally relate to power conversion, and, more particularly, to systems, devices, and/or methods for distributing power to sub-modules of a power converter.

### BACKGROUND

Energy conversion systems may be configured to convert energy discharged from a power source prior to the energy being provided to a load. For example, some Energy Storage Systems (ESS) may be configured to store and provide alternating current (AC) and/or direct current (DC) energy; and, in some cases, the ESS may be coupled to an alternating current (AC) system using an inverter device configured to convert DC power into AC power. The ESS may be configured to transmit the AC power to an AC port, thereby providing the AC power to an AC load, an electrical network, and/or the like. The inverter device may include one or more inverters configured to convert DC energy stored in the ESS into AC power and to convert AC power to DC power to be stored in the ESS as DC energy.

ESS, such as battery ESS (BESS), may rely on one or more battery modules configured to provide local loads (e.g., local energy storage, DC devices connected to the BESS, etc.) and one or more power converters configured to convert the DC energy provided from and/or stored in the one or more battery modules (e.g., in case of power outage and/or to store energy when electrical power provided by an electrical grid is present) into AC power. However, the battery modules may be low voltage rated (e.g., capable of only providing relatively low voltage output, etc.), and therefore may cause a high input current to be provided to the one or more power converters.

Some power converters, including Dual Active Bridges (DAB) power converters and Multi-Active Bridges (MAB) power converters, may be used to provide bidirectional power transfer with galvanic isolation. DAB power converters generally include two or more active bridges, e.g., full-bridges formed using metal oxide semiconductor field effect transistor (MOSFETS). The two active bridges of the DAB power converters may be connected via a high-frequency transformer, which provides the galvanic isolation. MAB power converters extend the DAB topology by connecting more than two active bridges via a multi-winding transformer.

### SUMMARY

In the case of a BESS including more than one battery, the multiple batteries may be connected to a power converter in parallel; however, due to the low input voltage of the batteries, the total input current to the converter may become higher making the input connector more expensive (e.g., in production and in maintenance). For the same system power, a series connection between the battery modules results in a lower total input current compared to the parallel connection; however, the power converter's input voltage is now much higher (e.g., the nominal voltage triples for a system including three series-connected batteries in a BESS compared to the same system including only a single battery in the BESS). Accordingly, using the series connection between the battery modules would require increasing the voltage rating of the input power semiconductors to the voltage determined by the multiple battery modules, while the current rating would still have to cover the full input current range.

The disclosure has been made in view of the above problems, and at least one object of at least one example embodiment of the inventive concepts is to compensate for the higher voltage rating in cases where the plurality of DC sources (e.g., the batteries of the BESS, etc.) are connected in series, and/or reconfigurable circuitry is disclosed to augment the operation of the power converter.

According to at least one example embodiment of the inventive concepts, there is provided a modular converter comprising a first converter switching cell configured to convert a first input into a first output; a second converter switching cell configured to convert the first input into a second output; a modular connector between the first converter switching cell and the second converter switching cell, the modular connector configured to switch between a first connection state and a second connection state, the first connection state connecting a first-port of the first converter switching cell and a first-port of the second converter switching cell in series, and the second connection state connecting the first-port of the first converter switching cell and first port of the second converter switching cell in parallel; and a transformer configured to combine the first output and the second output to form a combined output, wherein the first input is at least one of a direct current (DC) or alternating current (AC), and the first output, the second output, and the combined output are AC.

According to at least one example embodiment of the inventive concepts, there is provided an energy conversion system including: a power system configured to generate a first input; a first converter switching cell configured to convert the first input into a first output; a second converter switching cell configured to convert the first input into a second output, a modular connector between the first converter switching cell and the second converter switching cell, the modular connector configured to switch between a first connection state and a second connection state; and a transformer configured to combine the first output and the second output to form a combined output, wherein the first connection state connects a first-port of the first converter switching cell and a first-port of the second converter switching cell in series, the second connection state connects the first-port of the first converter switching cell and the first-port of the second converter switching cell in parallel, the first input is at least one of a direct current (DC) or alternating current (AC), and the first output, the second output, and the combined output are AC.

According to at least one example embodiment of the inventive concepts, there is provided a battery energy storage system (BESS) comprising: a battery power supply configured to discharge direct current (DC) as a DC input; and an energy conversion system, the energy conversion system including a first converter switching cell configured to convert the DC input into a first output, a second converter switching cell configured to convert the DC input into a second output, a modular connector between the first converter switching cell and the second converter switching cell, and a transformer configured to combine the first output and the second output to form a combined output, wherein the modular connector is configured to switch between a first connection state and a second connection state, wherein the first connection state connects a DC port of the first converter switching cell and a DC port of the second converter switching cell in series, the second connection state connects the DC port of the first converter switching cell and the DC port of the second converter switching cell in parallel, and the first output, the second output, and the combined output are AC

The disclosure is not limited to the above description, and other configurations and tasks not described herein will be clearly understood by those skilled in the art from the following description.

### BRIEF DESCRIPTION OF THE DRAWINGS

FIG. 1 is an illustration of an example energy conversion system including a multiple-active bridge (MAB) according to at least one example embodiment.

FIG. 2A is an illustration of a bidirectional energy conversion system according to some example embodiments; FIG. 2B is diagram of a first-side module according to some example embodiments; and FIG. 2C is diagram of a second-side module according to some example embodiments.

FIG. 3 is an illustration of a circuit diagram for an example energy conversion system according to some example embodiments.

FIGS. 4A and 4B are illustrations of an example modular converter according to at least some example embodiments.

FIGS. 5A and 5B are illustrations of an example modular converter in different first-side connection states, according to at least some example embodiments.

FIG. 6A is an illustration of a bidirectional switching circuit in the first connection state according to some example embodiments; and FIG. 6B is an illustration of the bidirectional switching circuit in the second connection state according to some example embodiments.

FIG. 7A is a schematic diagram for a system according to some example embodiments. FIG. 7B illustrates example control signals for the system according to some example embodiments; and FIG. 7C illustrates an example unipolar modulation according to some example embodiments.

### DETAILED DESCRIPTION

Hereinafter, one or more example embodiments of the inventive concepts will be described in detail with reference to the accompanying drawings so that those of ordinary skill in the art can understand the inventive concepts. The example embodiments may be embodied in various different forms and is not limited to the example embodiments described herein. In order to clearly describe the example embodiments of the inventive concepts, parts not related to the description are omitted in the drawings, and the same reference numerals are used to refer to the same or similar elements throughout the specification.

The words and terms used in the specification and the claims are not to be construed as limited to ordinary or dictionary meanings, but should be construed as meanings and concepts corresponding to technical aspects of the example embodiments of the inventive concepts.

Therefore, one or more example embodiments described in the specification and the configurations illustrated in the drawings do not represent all of the technical aspects of the inventive concepts, and thus the corresponding configurations may have various equivalents and modifications to replace them in the described example embodiments.

It should be understood that the terms such as “include” or “have” are intended to describe the presence of stated features, numbers, steps, operations, elements, components, or combinations thereof, and do not preclude the presence or addition of one or more other features, numbers, steps, operations, elements, components, or combinations thereof. Additionally, although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

It is to be understood that any element is located in the “front”, “rear”, “above” or “below” of another element, unless otherwise defined, not only is located in the “front”, “rear”, “above” or “below” immediately adjacent to the other element, but also includes a case in which another element is located in the middle. In addition, it is to be understood that any element is “connected” to another element, unless otherwise defined, not only is directly connected to each other but also includes a case in which the element is indirectly connected to each other.

Whenever a range of values is recited, the range includes all values that fall within the range as if expressly written, and the range further includes the boundaries of the range. Thus, a range of “X to Y” includes all values between X and Y and also includes X and Y.

In order to clearly explain the example embodiments in the drawings, parts that are not related to the description are omitted, and similar parts are given similar reference numerals throughout the specification. In the methods described herein, the order of operations may be changed, several operations may be merged, certain operations may be divided, and certain operations may not be performed.

It will be understood that elements and/or properties thereof may be recited herein as being “identical”, “the same”, or “equal” as other elements and/or properties thereof, and it will be further understood that elements and/or properties thereof recited herein as being “identical” to, “the same” as, or “equal” to other elements and/or properties thereof may be “identical” to, “the same” as, or “equal” to or “substantially identical” to, “substantially the same” as or “substantially equal” to the other elements and/or properties thereof. Elements and/or properties thereof that are “substantially identical” to, “substantially the same” as or “substantially equal” to other elements and/or properties thereof will be understood to include elements and/or properties thereof that are identical to, the same as, or equal to the other elements and/or properties thereof within manufacturing tolerances and/or material tolerances. Elements and/or properties thereof that are identical or substantially identical to, equal to or substantially equal to, and/or the same or substantially the same as other elements and/or properties thereof may be structurally the same or substantially the same, functionally the same or substantially the same, and/or compositionally the same or substantially the same. While the term “same,” “equal” or “identical” may be used in description of some example embodiments, it should be understood that some imprecisions may exist. Thus, when one element or property is referred to as being identical to, equal to, or the same as another element or property, it should be understood that the element or property is the same as another element or property within a desired manufacturing or operational tolerance range (e.g., ±10%).

When the terms “about” or “substantially” are used in this specification in connection with a numerical value, it is intended that the associated numerical value includes a manufacturing or operational tolerance (e.g., ±10%) around the stated numerical value. It will be understood that elements and/or properties thereof described herein as being “substantially” the same, equal, and/or identical encompasses elements and/or properties thereof that have a relative difference in magnitude that is equal to or less than 10%. Moreover, when the words “about” and “substantially” are used in connection with geometric shapes, it is intended that precision of the geometric shape is not required but that latitude for the shape is within the scope of the disclosure. Further, regardless of whether numerical values or shapes are modified as “about” or “substantially,” it will be understood that these values and shapes should be construed as including a manufacturing or operational tolerance (e.g., ±10%) around the stated numerical values or shapes. When ranges are specified, the range includes all values therebetween such as increments of 0.1%.

A control sequence may represent a procedure, a function, a program of instructions, a subprogram, a program, a routine, a subroutine, a module, a software package, a class, or any combination of instructions, data structures, or program statements. A control sequence may be coupled to another control sequence or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

As used in this application, the term “circuitry” and/or “hardware circuitry” may refer to one or more or all of the following: (a) hardware-only circuit implementation (such as implementations in only analog and/or digital circuitry); (b) combinations of hardware circuits and software, such as (as applicable): (i) a combination of analog and/or digital hardware circuit(s) with software/firmware, and (ii) any portions of hardware processor(s) with software (including digital signal processor(s)), software, and memory (and/or memories) that work together to cause an apparatus, such as a mobile phone or server, to perform various functions); and (c) hardware circuit(s) and/or processor(s), such as microprocessor(s) or a portion of a microprocessor(s), that requires software (e.g., firmware) for operation, but the software may not be present when it is not needed for operation. For example, the circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware.

Hereinafter, some example embodiments will be described with reference to the drawings.

### Modular Multi-Bridge Converter

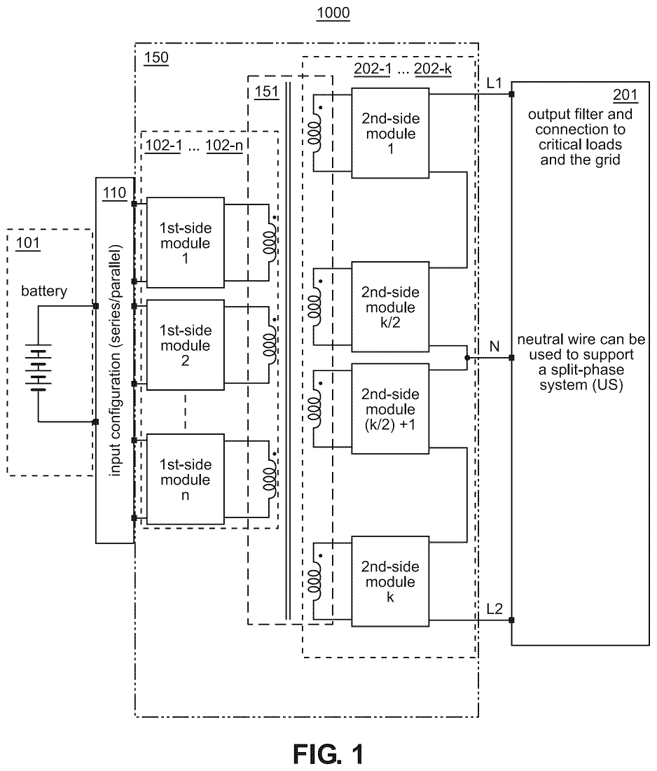

FIG. 1 is an illustration of an example energy conversion system including a multiple-active bridge (MAB) according to at least one example embodiment.

In some example embodiments, the energy conversion system 1000 includes at least one power device (herein the power supply, battery, and/or first power system 101), and a second power system 201, but the energy conversion system 1000 is not limited thereto, and for example, may include a greater or lesser number of elements, etc. The energy conversion system 1000 may further include a converter stage including a first switching circuit 102 and a second switching circuit 202, but is not limited thereto. The first switching circuit 102 may include a plurality of first modules 102-1 through 102-n. The second switching circuit 202 may include one or more second modules (e.g., 202-1 through 202-k). The first switching circuit 102 (and/or the plurality of first modules 102-1 through 102-n) may be configured to form a multiple-active bridge (MAB) 150 with the one or more second modules 202-1 through 202-k of the second switching circuit 202. In at least one example embodiment, the MAB 150 may include a multi-winding transformer (MWT) 151 which may magnetically couple the plurality of first modules 102-1 through 102-n to the one or more second modules 202-1 through 202-k. In at least one example embodiment, the MAB 150 may include, e.g., a 3-winding transformer, a 4-winding transformer, etc., which may magnetically couple the plurality of first modules 102-1 through 102-n to the one or more second modules 202-1 through 202-k. The first modules 102-1 through 102-n may be referred to as first-side modules 102-1 through 102-n. In at least some example embodiments, the first power system 101 may be a DC power source, and the first-side modules 102-1 through 102-n may be on the DC side of the MAB 150, and therefore, in these cases, the first-side modules 102-1 through 102-n may also be referred to as DC-side modules 102-1 through 102-n. Additionally, the second modules 202-1 through 202-k may be referred to as second-side modules 202-1 through 202-k. In at least some example embodiments, the second-side modules 202-1 through 202-k may be on a side of the MAB 150 with a higher voltage compared to the DC side, and therefore may be referred to high-voltage (HV)-side modules 202-1 through 202-k and/or may be on an AC side of the MAB 150, and therefore, in these cases, the second-side modules 202-1 through 202-k may be referred to AC-side modules 202-1 through 202-k. In at least one example embodiment, the first-side modules 102-1 through 102-n and the second-side modules 202-1 through 202-k may also be referred as DC-side (or first-side) converter switching cells and second side (or AC-side or HV-side) converter switching cells, respectively. For example, in the case where the energy conversion system 1000 is a DC-AC converter, the first-side modules 102-1 through 102-n may be referred to as DC-side converter switching cells and the second-side modules 202-1 through 202-k may be referred to as AC-side converter switching cells, etc.

The first power system 101 may be configured to supply DC or AC power. For example, in some example embodiments the first power system 101 may be at least one of an electrical power source and/or device (e.g., any known power source), an electrical load, an electrical network or grid, or any combination thereof. In some example embodiments, the first system 101 may be configured to supply, circulate, or draw direct current (DC) or alternating current (AC). For example, in at least one example embodiment, the first power system 101 may be configured to supply a DC input (e.g., DC energy, DC power, etc.) from one DC power source and/or from a plurality of DC power sources and/or may be configured to store a DC input in one DC power source and/or in a plurality of DC power sources. The first power system 101 may be configured as a modular DC source such that the first power system 101 may switch between a lower voltage state (e.g., a singular source state) and a higher voltage source state (e.g., a multi-source state). For example, the DC power source may be a battery; and in such cases the first power system 101 may be configured to supply DC power either in the singular source state including only one battery or the multi-source state including a plurality of batteries connected in series. However, this is only an example, and the first power system 101 may include a different DC power source, for example, one or more of a chemistry based DC source (e.g., a fuel cell and/or chemical battery, etc.), a capacitance based DC source (a capacitor, a super capacitor, etc.), a semiconductor based DC source (e.g., a solar cell, a photovoltaic cell, etc.), and/or the like. Alternatively, the first power system 101 may also include an AC power source, including a generator, a turbine, and/or the like.

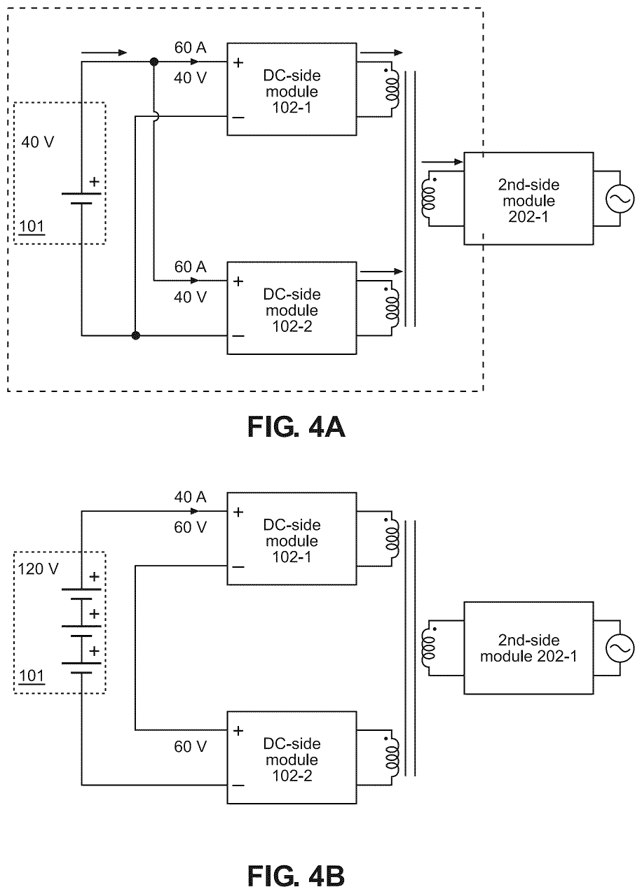

The first power system 101 may be electrically connected to the plurality of first-side modules 102-1 through 102-n in series or in parallel. The connection between two or more of the plurality of first-side modules 102-1 through 102-n may be modular (e.g., adjustable and/or configurable) such that a modular connection 110 (e.g., an adjustable connection, a temporary connection, and/or a configurable connection, etc.) may be provided between the first power system 101 and the plurality of first-side modules 102-1 through 102-n to compensate for differences in the amperages and/or voltages of the singular power device state compared to the amperages and/or voltages of the multi-power device state. For example, as discussed in further detail in reference to FIGS. 4A through 6B, a modular connector 110 may be connected between the first power system 101 and the plurality of first-side modules 102-1 through 102-n.

Further, although FIG. 1 illustrates an example wherein there are at least three first-side modules (e.g., 102-1, 102-2, and 102-n) and wherein there are at least four second-side modules (e.g., 202-1, 202-2, 202-3, and 202-k) the number (“n”) of first-side modules 102-1 through 102-n is modular (e.g., adjustable, temporary, configurable, etc.). For example, in at least one example embodiment, the number n of the first-side modules 102-1 through 102-n may be adjusted and/or changed during the lifetime of the energy conversion system 1000. In other words, the energy conversion system 1000 may include a plurality of first-side modules 102-1 through 102-n, wherein the number (“n”) of first-side modules 102-1 through 102-n is chosen based on at least one of battery voltage, primary DC bus voltage, power level, and/or the like. Thereby, the number (“n”) of the first-side modules 102-1 through 102-n and/or the ratio of the number (“n”) of the first-side modules 102-1 through 102-n to the number (“k”) of second-side modules 202-1 through 202-k (e.g., a ratio of n:k) may be adjusted based on the operational conditions of the energy conversion system 1000 and/or system operator preferences, etc. Additionally, in at least one example embodiment, the number (“k”) of second-side modules 202-1 through 202-k may be modular (e.g., adjustable, temporary, configurable, etc.).

The plurality of first-side modules 102-1 through 102-n and the plurality of second-side modules 202-1 through 202-k may each be (and/or may include) a converter switching cell and may be configured to convert and/or transform one or more input electrical signals into one or more output electrical signals. The converter switching cells may each include components (e.g., one or more of a diode, a switch (e.g., a transistor, etc.), a capacitor, etc.) which are configured as one or more of a rectifier, a smoothing circuit, a resonant circuit, a converter, a cycloconverter, and/or the like. Thereby, a first-side converter circuit may comprise a plurality of first-side modules 102-1 through 102-n, each including a converter switching cell; and/or a second-side converter circuit may comprise a plurality of second-side modules 202-1 through 202-k, each including a converter switching cell, but the example embodiments are not limited thereto.

In some example embodiments, each of the plurality of first-side modules 102-1 through 102-n may be configured to generate an AC output based on an input (e.g., from the power system 101). The first switching circuit 102 may be further configured to be coupled to the MWT 151, the MWT 151 may be configured to combine two or more of the outputs of the plurality of first-side modules 102-1 through 102-n to generate a combined output and to supply the combined output to each of the one or more second-side modules 202-1 through 202-k via the MWT 151. In other words, since each of the one or more second-side modules 202-1 through 202-k may receive the combined output and since each of the one or more second-side modules 202-1 through 202-k may receive the same combined output, the number of “combined outputs” generated by the MWT 151 may be the same as the number “k” of second-side modules 202-1 through 202-k. The input received by the plurality of first-side modules 102-1 through 102-n may be AC or DC; and the plurality of first-side modules 102-1 through 102-n may be configured such that the outputs of the plurality of first-side modules 102-1 through 102-n and the combined output are AC.

In some example embodiments, the plurality of first-side modules 102-1 through 102-n may be configured to be magnetically coupled to the plurality of second-side modules 202-1 through 202-k by a MWT 151, thereby forming a MAB 150. For example, in at least some example embodiments, each of the plurality of first-side modules 102-1 through 102-n and each of the second-side modules 202-1 through 202-k may include (and/or may be electrically connected to) an induction coil, and the energy conversion system 1000 may be configured such that the induction coils of the plurality of first-side modules 102-1 through 102-n are configured to form a magnetic coupling with one or more of the induction coils of the plurality of second-side modules 202-1 through 202-k. In at least one embodiment, the current of the DC input is passed through one or more switching cells, thereby generating AC power, and the AC power is passed through the induction coils of the plurality of first-side modules 102-1 through 102-n and received by the plurality of second-side modules 202-1 through 202-k.

For example, in at least one example embodiment, the energy conversion system 1000 may be configured such that the magnetic field produced by the induction coils of the plurality of first-side modules 102-1 through 102-n induces the flow of current in the induction coils of the plurality of second-side modules 202-1 through 202-k.

Additionally, in at least one example embodiment, the energy conversion system 1000 may operate in a bi-directional manner such that energy may be provided to and stored in the first power system 101 from the second-side (e.g., from energy received from a second power source and/or a second power device, such as the second power system 201, an electrical grid, etc.). For example, in the case where an input is provided from the second-side, the energy conversion system 1000 may be configured such that a magnetic field produced by the induction coils of the plurality of second-side modules 202-1 through 202-k interacts with a magnetic field in the induction coils of the plurality of first-side modules 102-1 through 102-n, thereby inducing the flow of current in the induction coils of the plurality of first-side modules 102-1 through 102-n. In these cases, the energy conversion system 1000 may be referred to as a bi-directional converter and/or an energy conversion system capable of supporting bi-directional power conversion, etc. In at least some example embodiments, the MAB 150 may be configured such that each of the plurality of second-side modules 202-1 through 202-k are coupled to two or more of the plurality of first-side modules 102-1 through 102-n, such that the induction of current in each of the first-side modules 102-1 through 102-n is based on the combined outputs of the two or more plurality of second-side modules 202-1 through 202-k. In other words, a first output of one of the plurality of second-side modules 202-1 through 202-k and a second output of another of the plurality of second-side modules 202-1 through 202-k may be combined to form the combined output, which is provided to (e.g., received by) at least one of the plurality of first-side modules 102-1 through 102-n. In at least some example embodiments, the MAB 150 may further include a core (e.g., magnetic core, etc.) configured to concentrate/guide the magnetic fields of the primary coils.

The induction coils inducing the current may also be referred to as primary coils (or primary windings) and the induction coils including the current being induced may be referred to as secondary coils (or secondary windings). In at least some example embodiments, both the primary coils and the second coils may be active, such that voltages are applied to both the primary coils and the secondary coils. In such cases, power is generated based on the difference in voltage therebetween. In at least some example embodiments, the output of two or more primary coils (or primary windings) may be combined to generate power in a secondary coil (or secondary winding) coupled to the two or more primary coils. Thereby, in a bi-directional transformer, the primary and secondary coils may change based on the source of the input.

The energy conversion system 1000 may further include a second power system 201 configured to transfer signals from and/or to the converter stage. For example, in some example embodiments the second power system 201 may be at least one of an electrical power source and/or device (e.g., any known power source), an electrical load, an electrical network or grid, or any combination thereof. In some example embodiments, the second power system 201 may be configured to supply, circulate, or draw direct current (DC) or alternating current (AC). For example, the second power system 201 may be an output filter, connection, and/or port, etc., configured to receive the converted electrical signal from the converter stage and/or to transmit an electrical signal for converting to the converter stage.

In at least some example embodiments, the second power system 201 may be at least one AC port, connected to an AC grid and/or an AC load, etc. For example, the second power system 201 may be configured to be connected to, e.g., a power grid, a single-phase system, a two-phase system, a three-phase system, and/or a split-phase system, etc., but is not limited thereto. In at least some example embodiments, the second power system 201 may include dual lead lines L1 and L2 and a neutral wire N, but is not limited thereto. The neutral wire N may be configured to support a split-phase system. However, this is only an example, and the example embodiments are not limited thereto. For example, the second power system 201 may be configured as a split-phase AC output and/or as a single-phase AC output including a lead line and a neutral line, two lead lines (L1 and L2), etc. In some example embodiments, the second power system 201 may also include additional circuitry, such as a filter circuit and/or the like.

In some example embodiments, the MAB 150 comprising ‘n’ first-side modules 102-1 through 102-n and ‘k’ second-side modules 202-1 through 202-k may be configured to regulate the voltages and/or currents on the primary and/or the secondary sides using phase shifts between switching pulses across the MAB 150. Additionally, a simplified design of split-phase operation (with multiple modes of operation including, but not limited to, a connection between only L1 and N such that no power is between N and L2, a connection between only N and L2 such that no power is between N and L1, and/or both connections, etc.) may result from all of the primary coils being coupled to the secondary coils (as with a multi-winding transformer). For example, in such a configuration, all of the primary coils may be active and may equally process power even if half of the secondary coils are inactive (e.g., not processing power) as is the case for some split-phase operations.

According to at least one example embodiment, the modular and/or reconfigurable MAB 150 allows for the use of components (e.g., transistors, capacitors, diodes, etc.) rated for lower-voltages even when a voltage of the first power system 101 is greater than the rating of the individual components since the plurality of first-side modules 102-1 through 102-n may be connected in series. More specifically, because the voltage of the first power system 101 (e.g., a battery, etc.) is divided among the plurality of first-side modules 102-1 through 102-n, components having lower-voltage rating may be safely used in the MAB 150. Additionally, the modular and/or reconfigurable MAB 150 allows for a reduction of and/or lowering of conduction losses when the plurality of first-side modules 102-1 through 102-n are connected in parallel since current is shared among the first-side modules 102-1 through 102-n. For example, to produce multiple isolated DC links that may support a cascaded multi-level inverter stage, a multi-input multi-output (MIMO) MAB 150 is provided, thereby enabling the use of lower-voltage-rated components, such as transistors, etc., as well as providing isolation and reconfigurable first-side modules which can switch between a series connection and a parallel connection. In other words, the MAB 150 may be implemented via a modular multi-winding transformer, thereby providing for multiple configurations for one or more windings on both the primary and secondary sides.

The plurality of first-side modules 102-1 through 102-n and the plurality of second-side modules 202-1 through 202-k may be configured to generate an electrical output by converting an electrical input. For instance, in at least some example embodiments, the energy conversion system 1000 may be configured as an AC-AC converter, a DC-DC converter, and/or as a DC-AC converter. For example, in at least one example embodiment, the energy conversion system 1000 may be configured as a step-up/step-down converter configured to, based on the source of the input, increase (or “step-up”) the voltage of the input passing from the plurality of first-side modules 102-1 through 102-n to the plurality of second-side modules 202-1 through 202-k, or to decrease (or “step-down”) the voltage of an input passing from the plurality of second-side modules 202-1 through 202-k to the plurality of first-side modules 102-1 through 102-n. For example, in some example embodiments, the quantity of coils and/or the number of turns in said coils for the second-side modules 202-1 through 202-k may be greater than the quantity of coils and/or the number of turns in said coils for the first-side modules. As such the second-side modules 202-1 through 202-k and the first-side modules 102-1 through 102—may act as a step-down converter in cases where the primary current is provided from the second-side modules, and may act as a step-up converter in cases where the primary current is provided from the first-side modules. Alternatively, in at least some embodiment, the quantity of coils (and/or the number of turns in said coils) for the second-side modules 202-1 through 202-k may be less than, or the same as (or substantially similar to), the quantity of coils (and/or the number of turns in said coils) for the first-side modules.

In at least one example embodiment, the energy conversion system 1000 may be an DC-to-AC converter configured to convert an electrical input passing from the plurality of first-side modules 102-1 through 102-n to the plurality of second-side modules 202-1 through 202-k from DC power to AC power and/or to convert an electrical input passing from the plurality of second-side modules 202-1 through 202-k to the plurality of first-side modules 102-1 through 102-n from AC power to DC power.

In some example embodiments, the energy conversion system 100 may be a single stage converter or a multi-stage converter. Additionally, in at least some example embodiments, the plurality of first modules 102-1 through 102-n and the one or more second modules 202-1 through 202-k may each be a single stage converter or a multi-stage converter. Thereby, in at least some example embodiments, the energy conversion system 1000 may be and/or include a single stage DC-DC converter, a multi-stage DC-DC converter, a single stage DC-AC converter, and/or a multi-stage DC-AC converter, etc. For example, the energy conversion system 1000 may be a bidirectional step-up/step-down converter including a single stage configured to step-up and/or step-down the voltage of an electrical input, a bidirectional multi-stage converter including a plurality of step-up/step-down stages each configured to step-up and/or step-down the voltage of an electrical input, a bidirectional DC-AC converter including a single-stage configured to convert an electrical input from DC to AC and/or from AC to DC, or a bidirectional DC-AC converter including a plurality of stages (e.g., at least one of a step-up/step-down inverter, rectifier, a pulse-modulator, and/or the like) configured to convert an electrical input from DC to AC and/or from AC to DC, etc., but the example embodiments are not limited thereto.

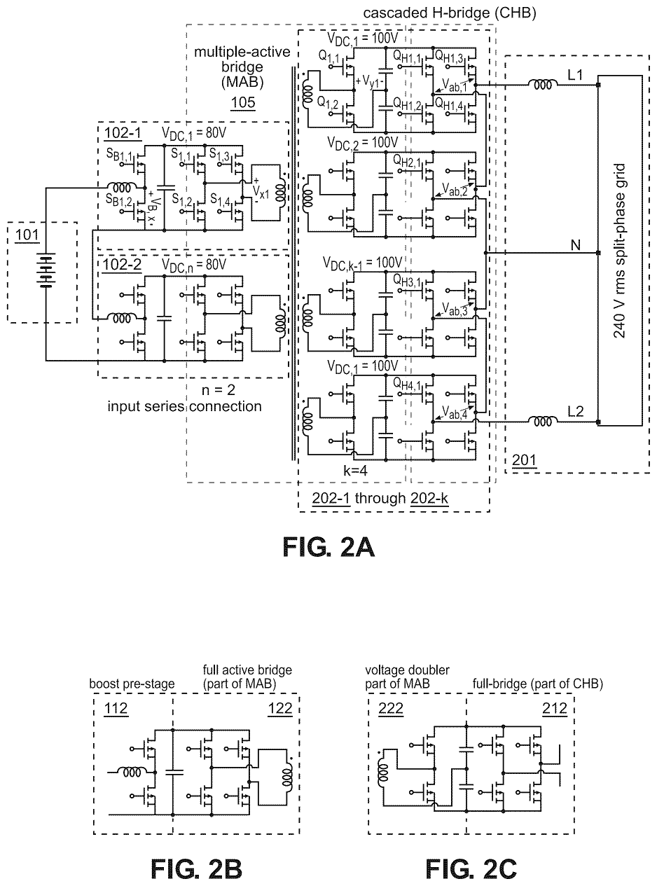

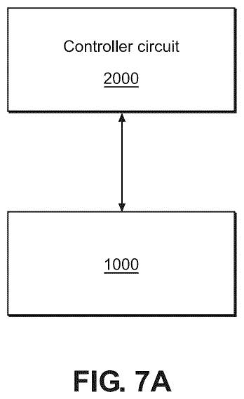

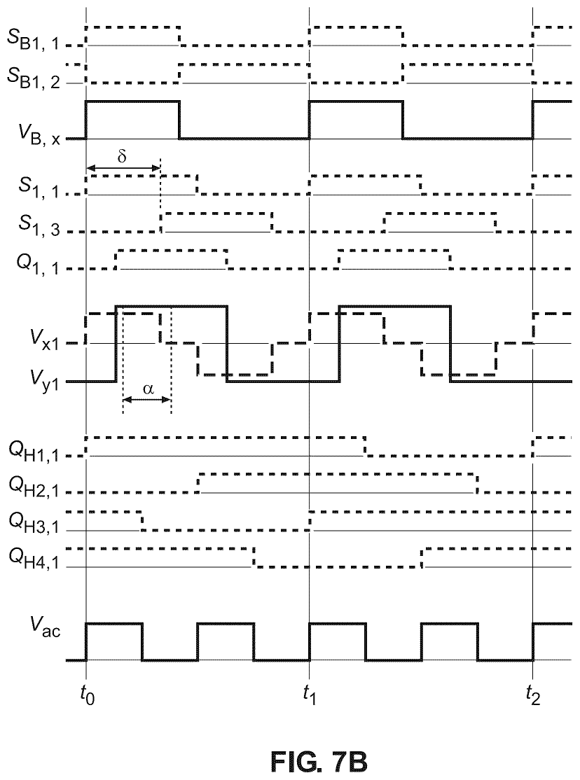

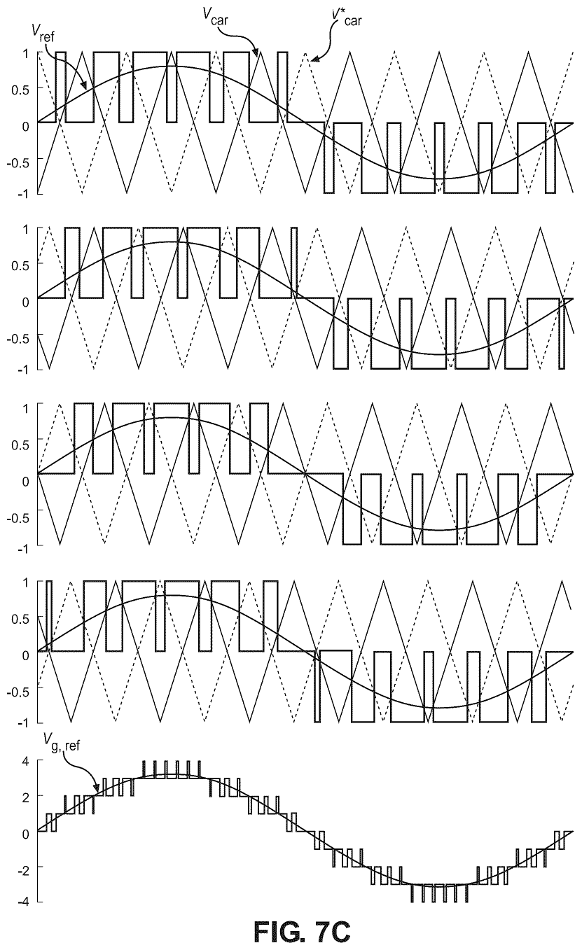

FIG. 2A is an illustration of a bidirectional energy conversion system according to some example embodiments; FIG. 2B is diagram of a first-side module according to some example embodiments; and FIG. 2C is diagram of a second-side module according to some example embodiments. FIG. 7A is a schematic diagram for a system according to some example embodiments. FIG. 7B illustrates example control signals for the system according to some example embodiments; and FIG. 7C illustrates an example unipolar modulation according to some example embodiments.

The energy conversion system illustrated in FIG. 2A is an example of the energy conversion system 1000 according to at least one example embodiment, and is provided as a bi-directional DC-AC converter configured to convert a DC input from the first power system 101 into an AC output, and to convert an AC input from the second power system 201 into a DC output. In such cases the energy conversion system 1000 may be configured to function as a DC-AC converter and/or an AC-DC converter, based on the direction of the power flow. However, the energy conversion system illustrated in FIG. 2A is only an example and the example embodiments are not limited thereto.

As shown in FIG. 2B, in some example embodiments, the first-side modules 102-1 and 102-2 include a boost pre-stage 112 and a bridge stage 122, but are not limited thereto. The boost pre-stage may be configured to regulate the step-up conversion of the battery voltage to a DC value for the primary side DC bus. Furthermore, having a boost pre-stage allows the MAB 150 to be designed to function as a DC transformer, with fixed bus voltages for the primary and secondary sides.

Thereby, for a power supply operation (e.g., power flowing from the left (e.g., the first power system 101) to the right (e.g., the second power system 201) in the circuit diagram of FIG. 2A), the boost pre-stage may be employed to regulate the step-up conversion of the voltage to a first value for the primary side (e.g., 80 V in FIG. 2A, but not limited thereto). Furthermore, having a boost pre-stage allows the multi-active bridge (MAB) 150 to have fixed bus voltages on the primary and secondary sides of the MAB 150 (e.g., 80 V and 100 V, respectively, in FIG. 2A, but not limited thereto), but the example embodiments are not limited thereto.

In some example embodiments, as shown in the FIG. 2A, the first-side modules 102-1 and 102-2 are implemented as a full-bridge stack including a plurality of full-bridge circuits each including one or more transistors, e.g., four transistors (e.g., metal-oxide-semiconductor field effect transistors (MOSFET)) and/or four diodes as shown in FIG. 2A, but not limited thereto), and the second-side modules 202-1 through 202-k are implemented as a half-bridge stack including “k” half-bridge circuits 222, but the example embodiments are not limited thereto. Each of the transistors may be configured to receive a timing signal (e.g., from a controller circuit 2000 (see FIG. 7A and FIG. 7B)). The inclusion of the half-bridge circuits 222 may reduce the turn ratio (e.g., the ratio of the number of turns in the primary winding to the number of turns in the secondary winding) of the transformer and thus may reduce the cost and/or may reduce the current losses of the power converter.

Additionally, rather than a switching circuit including only one high voltage module on the second-side, the MAB 150 may include a plurality (e.g., “k” number of second-side modules, where k>1) of the second-side modules 202-1 through 202-k, thereby increasing the flexibility of the converter by allowing for the use of components (e.g., switches, etc.) having lower-voltage ratings because the voltage imposed on the components may be reduced. The modular configuration further permits easier repairs to the second-side modules 202-1 through 202-k and/or first-side modules 102-1 through 102-n, e.g., in cases where the components are damaged, burnt out, and/or the like.

As shown in FIG. 2C, in some example embodiments, the MAB 150 may be configured to be resonant, (e.g., using capacitors in and/or connected to the voltage doubler configuration of the half-bridge circuits 222 to form resonance), and/or by adding discrete capacitors to the MAB 150 (e.g., in series with the windings), etc., but the example embodiments are not limited thereto.

In some example embodiments, the second-side modules 202-1 through 202-k are configured to be interfaced to the second power system 201 via a cascaded H-bridge (CHB) stage, but are not limited thereto. The CHB stage may include “k” H-bridge modules 212 connected in series. The H-bridge modules 212 may be configured as a full-bridge, and may also include the lower-voltage rated switches, but are not limited thereto.

For a power supply operation into a load (e.g., an electrical grid and/or a critical load, etc.), the CHB may be configured to generate an AC output, but is not limited thereto. In some example embodiments, another advantage of one or more example embodiments is that there may be a frequency multiplication effect, wherein the effective ripple frequency seen at a port is higher than the switching frequency, which may reduce the cost and/or size of a filter desired and/or required for the system, etc.

A power system may be connected across the full stack of the H-bridge modules 212 or, for split-phase operation, a neutral connection may be made at the middle output of the CHB stage (e.g., an output node between the H-bridge modules 212), splitting the AC signal supplied to the second power system 201 in two (e.g., into half of the total AC voltage), but the example embodiments are not limited thereto. Due to the modular nature of the circuit and the coupling of the multi-active bridges, split-phase operation may be accomplished using only half of the secondary stages' power processing.

For a charging operation, the power flow is reversed (e.g., from right to left in FIG. 2A), or in other words, from the second power system (e.g., an AC electrical grid, an AC load, etc.) 201 to the first power system 101, etc. In these cases, the H-bridge modules 212 are configured to regulate the “k” DC voltages (V_{DC,k}) and the bridge stage 122 of the MAB 150 is configured to regulate the “n” DC voltages (V_{DC,n}). Finally, the boost-pre-stage, acting as a buck stage, may charge the battery/batteries, but is not limited thereto.

In some example embodiments, the plurality of second-side modules 202-1 through 202-k may be provided as a second-side converter stage including a AC-DC stage (e.g., the voltage doubler) and a DC-AC stage (e.g., the CHB) working together. However, these are only some examples, and the example embodiments are not limited thereto. For example, in some example embodiments, the second-side converter stage may be directly interfaced (e.g., directly connected, etc.) to the AC grid, etc. In one or more of these examples, the second-side converter stage may include a high-frequency link and at least one of a cycloconverter and/or an unfolding stage, etc., and the voltage doubler configuration may be omitted, thus further reducing costs, but are not limited thereto. The cycloconverter may be a full-bridge or a half-bridge converter.

In some example embodiments, as shown in FIG. 7A, the modular energy conversion system 1000 may be connected to at least one controller circuit 2000. The controller circuit may include circuitry configured to control the modular energy conversion system 1000 by providing one or more timing signals to the transistors of the modular energy conversion system 1000. The timing signals may include, for example, a first set of timing signals S_{B1,1} and S_{B1,2} provided to a first set of transistors in the first-side modules 102, a second set of timing signals S_{1,1}, S_{1,2}, S_{1,3}, S_{1,4}, provided to a second set of transistors in the first-side modules 102, a third set of timing signals Q_{1,1} and Q_{1,2}, provided to a first set of transistors in the second-side modules 202, and/or a fourth set of timing signals Q_{H1,1}, Q_{H2,1}, Q_{H3,1}, and Q_{H4,1}, provided to a second set of transistors in the second-side modules 202, etc., but the example embodiments are not limited thereto.

The controller circuit 2000 may generate the first set of timing signals S_{B1,1} and S_{B1,2} to produce a first shared signal (V_{b,x}) such that the first set of timing S_{B1,1} and S_{B1,2} may be complementary to each other (e.g., the S_{B1,2} timing signal is the inverse of the S_{B1,1} timing signal, etc.), but the example embodiments are not limited thereto. The second set of timing signals S_{1,1}, S_{1,2}, S_{1,3}, S_{1,4}, may include a first group (S_{1,1} and S_{1,3}) and a second group (S_{1,2} and S_{1,4}). The controller circuit 2000 may generate the timing signals in each group such that they are staggered (e.g., are phase shifted, etc.) such that the rising edge of one of the signals (e.g., S_{1,3}) is delayed by a period δ from another signal (e.g., S_{1,1}), etc. In at least one example embodiment, the controller circuit 2000 may generate the second group (S_{1,2} and S_{1,4}) such that they are complementary to the first group (S_{1,1} and S_{1,3}), but is not limited thereto. The controller circuit 2000 may generate the third set of timing signals Q_{1,1} and Q_{1,2}, to produce a second shared signal (V_{y,1}), such that the third set of timing signals Q_{1,1} and Q_{1,2} may complement each other (e.g., the Q_{1,2} timing signal is the inverse of the Q_{1,1} timing signal, etc.), but the example embodiments are not limited thereto. In some example embodiments, the fourth set of timing signals Q_{H1,1}, Q_{H2,1}, Q_{H3,1}, and Q_{H4,1}, may produce a third shared signal (v_{ac}), and each of fourth set of timing signals Q_{H1,1}, Q_{H2,1}, Q_{H3,1}, and Q_{H4,1} may include a plurality of sub-signals (e.g., Q_{H1,1}, Q_{H1,2}, Q_{H1,3}, and Q_{H1,4}), but the example embodiments are not limited thereto.

In some example embodiments, as shown in FIGS. 7B and 7C, the controller circuit 2000 may generate the signals, e.g., Q_{H1,1}, Q_{H2,1}, Q_{H3,1}, and Q_{H4,1,} in order to control the modulation of the cascading H-bridge. The signals shown in FIG. 7B are an expanded example of signals at a specific point in time of FIG. 7C. For example, the timescale of FIG. 7C may be 1/60 seconds (60 Hz), and FIG. 7B may be 1/20000 seconds (20 kHz), but the example embodiments are not limited thereto.

In some example embodiments, the controller circuit 2000 may generate the sub-signals, e.g., Q_{H1,1}, Q_{H1,2}, Q_{H1,3}, and Q_{H1,4,} in order to control the modulation of the cascading H-bridge. For example, unipolar modulation, as shown in FIG. 7C, may be used where the control of Q_{H1,1} and Q_{H1,3} is the same; the control of Q_{H1,2}, and Q_{H1,4} is the same; and Q_{H1,2} is complementary to Q_{H1,1}. Q_{H1,1} and Q_{H1,3} may be generated by comparing a reference voltage v_{ref} to a carrier signal v_{car}. Q_{H1,2} and Q_{H1,4} may be generated by comparing a reference voltage v_{ref} to a carrier signal v*_{car}, (which is, for example, phase shifted from v_{car} by 180°), but the example embodiments are not limited thereto. Voltage V_{ab1} may be generated as shown in FIG. 7C at a second port of a second-side switching cell. If there are multiple second-side switching cells, signals Q_{H2,1} through Q_{H2,4}, etc., are controlled similarly, where the carrier signals may be phase shifted from the carrier for Q_{H1,1}, and voltage V_{ab2}, etc. are generated. For the cascaded H-bridge example, the voltages V_{ab,x} are connected in series at the output port of the modular converter to create V_{ac} as shown in FIG. 7C. However, this is only an example, and the example embodiments are not limited thereto.

As noted above, the modular energy conversion system 1000 may benefit from the application of components (e.g., transistors and/or capacitors, etc.) of lower-voltage ratings, and/or may provide a frequency multiplication feature which allows for a reduction in filter sizing.

Discrete transformers (e.g., two-winding, three-windings, four-windings, etc.) may be used to couple primary switching circuits to secondary switching circuits instead of a single integrated transformer solution (e.g., multiple-winding transformer, etc.).

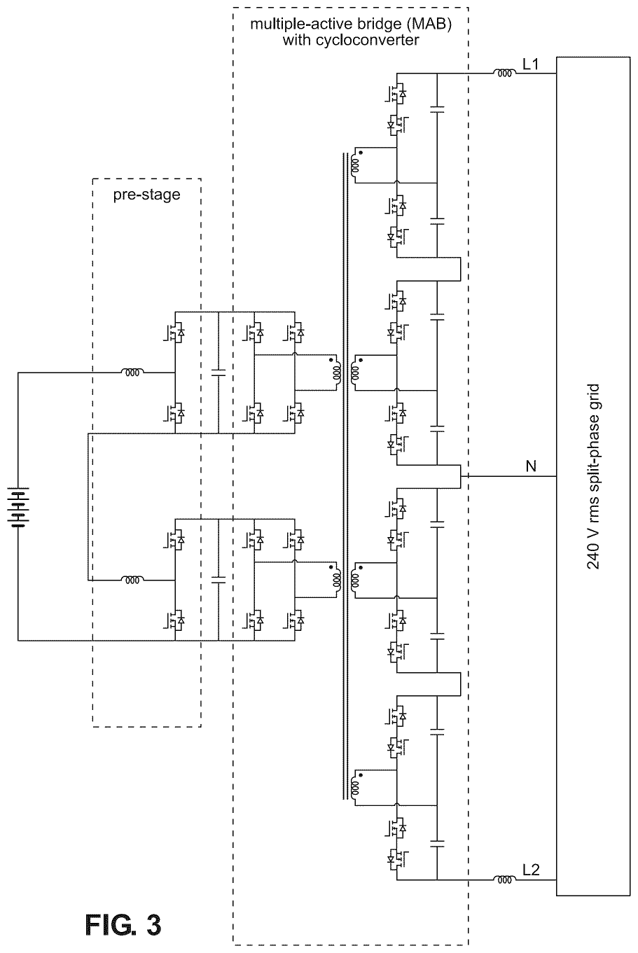

FIG. 3 is an illustration of a circuit diagram for an example energy conversion system according to some example embodiments. The energy conversion system illustrated in FIG. 3 is a DC-AC converter including cycloconverters in the plurality of second-side modules, but the example embodiments are not limited thereto. In the example illustrated in FIG. 3, the energy conversion system includes a battery module, two first-side modules, and four second-side modules, however this is only an example and the example embodiments are not limited thereto. As noted above, the energy conversion system illustrated in FIG. 3 is modular, and the number of first-side modules may be adjusted. As such, the ratio between the number of first-side modules and the number of second-side modules, etc., may also be adjusted.

Modular converter

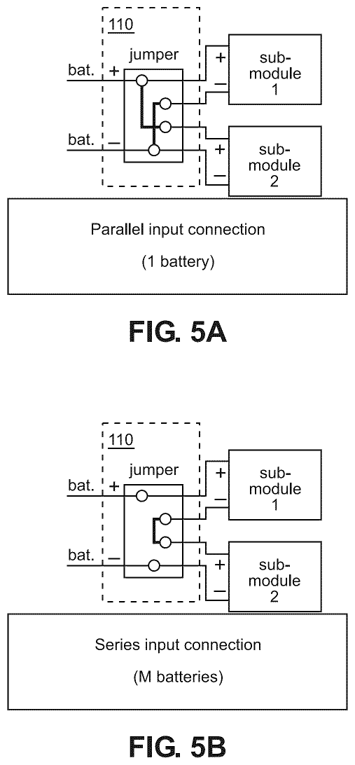

FIGS. 4A and 4B are illustrations of an example modular converter according to at least some example embodiments. FIGS. 5A and 5B are illustrations of an example modular converter in different input connection states, according to at least some example embodiments. FIGS. 4A and 4B depict an example where a power source is interfaced to an AC grid, and features a DC-AC stage split into two first-side modules 102-1 and 102-2 and an AC-AC stage including a second-side module 202-1; however, the example embodiments are not limited thereto. For example, the number of first-side modules 102-1 and 102-2 and second-side module 202-1, and/or stages are not limited to the numbers and/or values shown in the examples illustrated, and for example, may include a greater or lesser number of components, etc. Additionally, in at least one example embodiment, the first power system 101 may be a DC or AC power source, and may be configured to produce an input (e.g., a first input) such that the input is at least one of a direct current (DC) or alternating current (AC).

According to some example embodiments, the modular converter may include a modular (or first) switching circuit 102 including a plurality of first-side modules 102-1 and 102-2 and a second switching circuit 202 including one or more second-side modules 202-1 electromagnetically coupled to the plurality of first-side modules 102-1 and 102-2. The modular converter may include a power system 101 including a lower voltage power source (e.g., a one or more power devices (e.g., as shown in FIG. 4A)) and/or a higher voltage power source (e.g., a plurality of power devices connected in series (e.g., as shown in FIG. 4B)), but the example embodiments are not limited thereto. More specifically, the power system 101 may be modular such that the voltage of power system 101 is adjustable, and, for example, a user and/or system operator may add one or more power devices to the power system 101, remove one or more power devices from the power system 101, connect some of the power devices in parallel and/or series, etc. For example, in at least one example embodiment wherein the power devices are batteries, the number of batteries included in the power system 101 may be adjusted during the lifetime of an ESS and/or BESS including the modular converter. For example, the power system and/or power devices may be removed, repaired, and/or replaced during operation and/or maintenance, and/or additional power devices may be added during a scaling-up of operations and/or to change the electrical characteristics of the modular converter, etc. In at least one example embodiment, the lower voltage state may represent a state wherein the voltage supplied by the power system 101 has a voltage lower than the voltage rating of the components of the first switching circuit 102; and the higher voltage state may represent a state wherein the voltage supplied by of the power system 101 has a voltage greater than or equal to the voltage rating of the components of the first switching circuit 102 and/or the first-side modules 102-1 and 102-2 included in the first switching circuit 102.

The power devices may be, for example, a device configured to generate, store, and/or otherwise supply power, for example, batteries, solar cells, and/or fuel cells configured to store and discharge energy, but the example embodiments are not limited thereto. In at least one example embodiment, the first power system 101 may be (or include) a battery module (pack, system, etc.) and the one or more power devices may be one or more batteries, but the examples are not limited thereto. For example, the first power system 101 may be a collection of power devices electrically connected to each other and the power devices may be a subset of the collection. In other words, the power devices comprising the first power system 101 may each be a pack, module, cell, etc. In at least one example embodiment, the first power system 101 may be configured to accept at least one battery while in a first operational state (e.g., a first configuration, etc.), and to accept another (e.g., an additional) battery (or batteries) while in a second and/or different operational state (e.g., a second configuration, a third configuration, etc.). In other words, according to at least one example embodiment, the number of batteries in the second operational state, etc., may be greater than the number of batteries in the first operational state. Additionally, in at least one example embodiment, the voltage at the terminals of the first power system 101 may be greater in the second operational state, etc., compared to the first operational state.

In at least one example embodiment, as shown in FIG. 4A, a positive terminal of the first power system 101 may be connected to a positive input-terminal (or a positive first-terminal) of one of the plurality first-side modules 102-1, and a negative terminal of the first power system 101 may be connected to a negative input-terminal (or a negative first-terminal) of another of the plurality first-side modules 102-2, etc. In at least one example embodiment, as shown in FIG. 4B, a positive terminal of the first power system 101 may be connected to a negative input-terminal (or a negative first-terminal) of one of the plurality first-side modules 102-1, and a negative terminal of the first power system 101 may be connected to a positive input-terminal (or a positive first-terminal) of another of the plurality first-side modules 102-2, etc. Furthermore, in some example embodiments, at least some of the electrical connections (e.g., the electrical connection between the positive first-terminal of first-side module 102-1 to the first power system 101 and/or the connection between the negative first-terminal of first-side module 102-2 to the first power system 101, etc.), may be provided as non-reconfigurable connections.

Referring now to FIGS. 5A and 5B, a modular connector 110 may be provided between any two of the plurality of sub-modules 1 and 2 (e.g., first-side modules 102-1 and 102-2 and/or second-side modules 202-1, 202-2, etc.), but the example embodiments are not limited thereto and for example, there may be a greater number of jumpers and/or sub-modules, etc. In some example embodiments, the modular connector 110 may be and/or may include one or more jumper connectors, one or more relays, and/or similar electrical connectors. In at least one example embodiment, the one more jumper connectors of the modular connector 110 may include at least one jumper connector configured to connect two sub-modules of a plurality of sub-modules, such as two first-side modules of the first-side modules 102-1 through 102-n, but is not limited thereto. The modular connector 110 is configured to switch between a first connection state (e.g., as shown in FIG. 5A) and a second connection state (e.g., as shown in FIG. 5B), the second connection state connecting a first-port of the first converter switching cell and a first-port of the second converter switching cell in series (e.g., connecting a negative terminal of the first port of a first converter switching cell to a positive terminal of the first port of a second converter switching cell), and the first connection state connecting the first-port of the first converter switching cell and the first-port of the second converter switching cell in parallel (e.g., connecting a positive terminal of the first port of a first converter switching cell to a positive terminal of the first port of a second converter switching cell and connecting a negative terminal of the first port of a first converter switching cell to a negative terminal of the first port of a second converter switching cell), thereby allowing for the switching circuit to control and/or compensate for changes and/or modifications to the voltage and/or amperage of the input supplied from the first power system 101, etc.

For example, depending on the number of power devices included in the first power system 101, the first-side modules 102-1 and 102-2 may be connected either in series (e.g., as shown in FIGS. 4A and 5A, etc.) or in parallel (e.g., as shown in FIGS. 4B and 5B, etc.). Additionally, in the case wherein the first switching circuit 102 includes three or more first-side modules, the number of series and parallel connections between first-side modules may be adjusted to control and/or compensate for changes and/or modifications to the voltage and/or amperage caused by a change in the number of power sources included in the first power system 101, etc.

For example, for a lower voltage state (e.g., including a single DC power source) producing a voltage at the port of the first power system 101 (e.g., an input voltage of 40 V) and an terminal current (e.g., an input current of 120 A) and connected to ‘n’ first-side modules (102-1 and 102-2), the first-side modules 102-1 and 102-2 may be connected in parallel such that each of the first-side modules 102-1 and 102-2 receive the full input voltage (e.g., 40 V) and 1/n of the input current (if n=2, 60 A; if n=3, 40 A, etc.), but the example embodiments are not limited thereto, and for example, other voltage values may be used and/or the number of components may be adjusted. For a higher voltage state (e.g., including M batteries (wherein M is greater than 1)), some of the first-side modules 102-1 and 102-2 may be connected in series, such that each of the first-side modules 102-1 and 102-2 receives 1/n of the input voltage (if n=2 and M=3, 60 V) and the full input current (if M=3, 40 A), but the example embodiments are not limited thereto, and for example, other voltage values may be used and/or the number of components may be adjusted.

Thereby, the first-side modules 102-1 and 102-2 are reconfigurable and may operate as input-series or input-parallel; and, as discussed above, the outputs of the first-side modules 102-1 and 102-2 may be combined through a coupling with the second-side modules 202-1, via an isolation transformer, etc.

In at least some example embodiments, the first-side module 102-1 and 102-2 may be included in a plurality of first-side module 102-1 to 102-n. In some example embodiments, a modular connector 110 may be provided between each of the plurality of first-side module 102-1 and 102-n such that the modular connectors 110 may connect each of the plurality of first-side module 102-1 to 102-n in series or in parallel to a neighboring one of the plurality of first-side module 102-1 to 102-n. For example, in at least one example embodiment, a positive first terminal of the power system 101 may be connected to a positive first-terminal of a first first-side module 102-1, a first modular connector 110 may connect the negative first-terminal of the first first-side module 102-1 to a positive first-terminal of a second first-side module 102-2, a second modular connector 110 may connect the negative first-terminal of the second first-side module 102-2 to a positive first-terminal of a third first-side module 102-3, . . . , and a final modular connector 110 may connect the negative first-terminal of a penultimate first-side module 102-(n-1) to a positive first-terminal of a final first-side module 102-n, and the negative first-terminal of the first-side module 102-n may be connected to the negative terminal of the power system 101, etc. The plurality of modular connectors 110 may each be connected in the first connection state or the second connection state. Thereby, the plurality of first-side module 102-1 and 102-n may be connected to be all in series, all in parallel, or in any combinations thereof.

The modular converter may be configured such that reconfiguration between the first mode (e.g., first connection state, etc.) and the second mode (e.g., second connection state, etc.) is performed, e.g., during the installation and/or removal of a DC power source, etc. In other words, in some example embodiments, the configuration of the modular connector 110 may be changed, for example, during the lifetime of the energy conversion system, but not during the runtime (e.g., operation) of the converter, or in other words, the configuration of the modular connector 110 may be changed when the converter is offline and/or not in use, etc.

Therefore, because the voltage is divided between the plurality of first-side modules 102-1 through 102-2, components (e.g. transistors, capacitors, diodes, etc.) rated for relatively low-voltages may be applied in the plurality of first-side modules 102-1 through 102-2. In other words, the reconfigurability of the inputs allows for the use of components rated for low-voltage and/or low-current without reducing the efficiency of the modular converter 150, which reduces the costs and/or increases the efficiency of the energy systems such as ESS and/or DC systems.

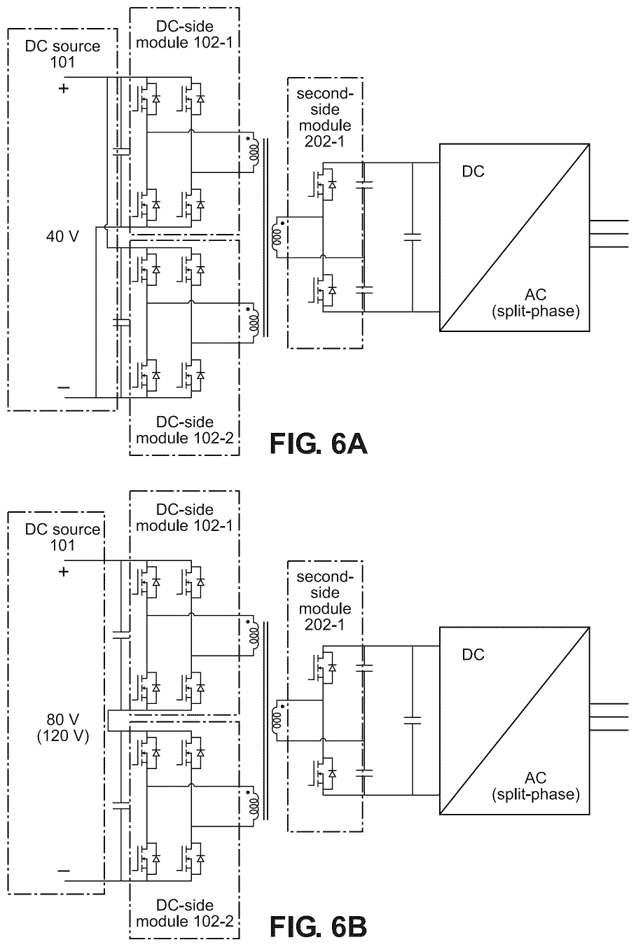

FIG. 6A is an illustration of a bidirectional switching circuit in the first connection state according to some example embodiments; and FIG. 6B is an illustration of the bidirectional switching circuit in the second connection state according to some example embodiments.

As shown in FIG. 6A, when the bidirectional switching circuit is connected to a first power system 101 (e.g., a battery module, etc.) including a lower-voltage state (e.g., only one DC power source), the first-side module 102-1 and the first-side module 102-2 may each receive the full voltage from the power system 101. For example, when the power system 101 is configured to output a signal at 40 V, each of the first-side module 102-1 and the first-side module 102-2 may receive the full 40 V, but the example embodiments are not limited thereto.

Alternatively, as shown in FIG. 6B, when the bidirectional switching circuit is connected to a power system 101 (e.g., a battery module, etc.) including a higher-voltage state (e.g., more than one DC power source, and/or wherein the voltage would be higher than a component's voltage rating), the first-side module 102-1 and the first-side module 102-2 may each receive a fraction (and/or subset) of the full voltage output by the power system 101. For example, when the power system 101 is configured to output a signal at 40 V and the power devices are connected in series, the full voltage of the power system 101 may be the sum of the voltages produced by the power devices (e.g., 80 V for two 40 V power sources, 120 V for three 40 V power sources, etc.). Since the voltage is divided evenly across a series circuit, each of the first-side module 102-1 and the first-side module 102-2 may receive a fraction (and/or a subset) of the full voltage. In other words, the voltage received by the first-side module 102-1 and the first-side module 102-2 may be based on the number ‘n’ of first-side modules.

In some example embodiments, the first-side module 102-1 and the first-side module 102-2 may each include a full-bridge inverter as a bridge stage 122. In some example embodiments, each of the first-side module 102-1 and the first-side module 102-2 may each include (or be connected to) at least one smoothing capacitor, etc. The first-side module 102-1 and the first-side module 102-2 may be coupled to a second-side module 202-1 such that the outputs of the first-side module 102-1 and the first-side module 102-2 are combined at the second-side module 202-1. Additionally, as discussed above, the second-side module 202-1 may be one of a plurality of second-side modules, and the plurality of second-side modules may be arranged in a stack, such that the outputs of the plurality of second-side modules may be combined and the combined output may be provided to a second power system 201, e.g., a load, an AC grid, etc.

Although some example embodiments of the inventive concepts are described, the spirit of the inventive concepts are not limited to the example embodiments presented in the specification, and those of ordinary skill in the art may easily propose other example embodiments within the same scope inventive concepts by adding, modifying, deleting, and adding components, but this is also within the scope of the inventive concepts.

1. A modular converter comprising:
a first converter switching cell configured to convert a first input into a first output;
a second converter switching cell configured to convert the first input into a second output;
a modular connector between the first converter switching cell and the second converter switching cell, the modular connector configured to switch between a first connection state and a second connection state, the first connection state connecting a first-port of the first converter switching cell and a first-port of the second converter switching cell in series, and the second connection state connecting the first-port of the first converter switching cell and first port of the second converter switching cell in parallel; and
a transformer configured to combine the first output and the second output to form a combined output,
wherein the first input is at least one of a direct current (DC) or an alternating current (AC), and
the first output, the second output, and the combined output are AC.

2. The modular converter of claim 1, wherein the transformer is a multi-winding transformer including at least one primary coil and at least one secondary coil, and
the transformer is configured to transmit power based on a difference in voltage between the at least one primary coil and the at least one secondary coil.

3. The modular converter of claim 1, wherein the modular converter is configured as a bi-directional converter.

4. The modular converter of claim 1, wherein one of the first converter switching cell or the second converter switching cell is configured to be connected to a positive terminal of a DC source.

5. The modular converter of claim 4, wherein the DC source is configured to include one or more batteries.

6. The modular converter of claim 1, further comprising:
a plurality of converter switching cells including three or more converter switching cells, the plurality of converter switching cells including the first converter switching cell and the second converter switching cell.

7. The modular converter of claim 6, wherein the transformer is further configured to combine outputs of the plurality of converter switching cells to form the combined output.

8. The modular converter of claim 6, further comprising:
a plurality of modular connectors, the plurality of modular connectors including the modular connector, and each of the plurality of modular connectors are configured to switch between the first connection state and the second connection state.

9. The modular converter of claim 1, wherein the modular connector is at least one of a jumper connector or a relay.

10. The modular converter of claim 1, further comprising:
at least one second-side converter switching cell configured to receive the combined output from the transformer.

11. The modular converter of claim 10, wherein the at least one second-side converter switching cell is a multi-stage converter.

12. The modular converter of claim 10, wherein the at least one second-side converter switching cell is a single stage converter.

13. The modular converter of claim 1, wherein at least one of the first converter switching cell or the second converter switching cell is a single-stage converter.

14. The modular converter of claim 1, wherein at least one of the first converter switching cell or the second converter switching cell is a multi-stage converter.

15. An energy conversion system including:
a power system configured to generate a first input;
a first converter switching cell configured to convert the first input into a first output;
a second converter switching cell configured to convert the first input into a second output,
a modular connector between the first converter switching cell and the second converter switching cell, the modular connector configured to switch between a first connection state and a second connection state; and
a transformer configured to combine the first output and the second output to form a combined output,
wherein the first connection state connects a first-port of the first converter switching cell and a first-port of the second converter switching cell in series,
the second connection state connects the first-port of the first converter switching cell and the first-port of the second converter switching cell in parallel,
the first input is at least one of a direct current (DC) or an alternating current (AC), and
the first output, the second output, and the combined output are AC.

16. The energy conversion system of claim 15, wherein the power system includes a battery module configured to include at least one battery.

17. The energy conversion system of claim 16, wherein the battery module is further configured to accept at least one additional battery and to connect the at least one battery and the at least one additional battery.

18. The energy conversion system of claim 15, wherein the energy conversion system is bidirectional such that the power system is further configured to receive energy from the first converter switching cell and the second converter switching cell.

19. A battery energy storage system (BESS) comprising:
a battery power supply configured to discharge direct current (DC) as a DC input; and
an energy conversion system, the energy conversion system including a first converter switching cell configured to convert the DC input into a first output, a second converter switching cell configured to convert the DC input into a second output, a modular connector between the first converter switching cell and the second converter switching cell, and a transformer configured to combine the first output and the second output to form a combined output,
wherein the modular connector is configured to switch between a first connection state and a second connection state,
wherein the first connection state connects a DC port of the first converter switching cell and a DC port of the second converter switching cell in series,
the second connection state connects the DC port of the first converter switching cell and the DC port of the second converter switching cell in parallel, and
the first output, the second output, and the combined output are alternating current (AC).

20. The BESS of claim 19, wherein the energy conversion system is bidirectional such that the battery power supply is further configured to be charged by the energy conversion system.
